(19) United States
(12) Patent Application Publication
(10) Pub. No.: US 2015/0008252 A1
(43) Pub. Date: Jan. 8, 2015

(54) MANUFACTURING METHOD FOR A SHIELD CONDUCTOR

(71) Applicant: SUMITOMO WIRING SYSTEMS, LTD., Yokkaichi (JP)

(72) Inventors: Hirokazu NAKAI, Yokkaichi (JP); Yuki OOHIRA, Yokkaichi (JP)

(21) Appl. No.: 14/311,087

(22) Filed: Jun. 20, 2014

(30) Foreign Application Priority Data
Jul. 4, 2013 (JP) 2013-140917

(51) Int. Cl. H01B 13/22; B23K 1/06; B23K 1/00

(52) U.S. Cl. CPC H01B 13/22; B23K 1/0016; B23K 1/06; B23K 2001/12
USPC 228/110.1; 228/249

(57) ABSTRACT

A method is disclosed for manufacturing a shield conductor by connecting a metallic braid part formed of tubularly braided metallic wire to a part to be connected provided with a tubular part having electrical conductivity. The method includes fitting the metallic braid part to an outer peripheral surface of an end part of the tubular part to form a fitting region; attaching a metallic welding band formed in a ring shape in the fitting region with the metallic braid part fitted to the end part of the tubular part; melting the welding band that is attached in the fitting region; and welding the tubular part to the metallic braid part along a circumferential direction of the tubular part.

### BACKGROUND

This application claims priority to JP 2013-140917 filed in Japan on Jul. 4, 2013, the entire disclosure of which is hereby incorporated by reference in its entirety.

The present invention relates to a method of manufacturing a shield conductor.

Conventionally, in hybrid vehicles and electric vehicles, a wire harness routed between, for example, a battery and an inverter, or between an inverter and a motor is often inserted in a metallic shield pipe and wired. The shield pipe is arranged beneath a vehicle body floor along a front to rear direction. This shield pipe has a function of shielding an electrical wire and a function of protecting the electrical wire from debris. After being installed inside the engine compartment, the shield pipe is connected with an inverter side via a metallic braid part having flexibility, and is arranged to increase the degree of freedom of the wire harness in a routing direction. The metallic braid part has metallic wire braided in a mesh form, is placed over an end part of the metallic pipe, and is connected typically by caulking with a caulking ring. See, for example, Japanese Patent Application Publication No. 2006-311699.

### SUMMARY

As explained above, the shield pipe and the metallic braid part constitute a shield conductor for the wire harness. The shield pipe and the metallic braid part are typically connected and fixed by caulking with a caulking ring. However, in such a connection method which uses caulking, it is difficult to make the metallic braid part contact an outer peripheral surface of the shield pipe uniformly for the entire periphery, and there is room for improvement with respect to electrical contact reliability. Also, it is to be noted that using a caulking ring increases the number of components.

Preferred embodiments were made in view of circumstances such as those discussed above and have as an object increasing the reliability, in a shield conductor, of electrical contact between a metallic braid part and a part to be connected.

A method of manufacturing a shield conductor according to a preferred embodiment by connecting a metallic braid part formed of tubularly braided metallic wire to a part to be connected provided with a tubular part having electrical conductivity includes (i) fitting the metallic braid part to an outer peripheral surface of an end part of the tubular part to form a fitting region; (ii) attaching a metallic welding band formed in a ring shape in the fitting region with the metallic braid part fitted to the end part of the tubular part; (iii) melting the welding band that is attached in the fitting region; and (iv) welding the tubular part to the metallic braid part along a circumferential direction of the tubular part.

In a preferred embodiment, the metallic braid part and the tubular part can be welded along the circumferential direction by melting the welding band. Therefore, in comparison with the prior art which forms the connection by caulking with a caulking ring, the reliability of electrical contact is high, and a decrease in the number of components can be achieved.

### BRIEF DESCRIPTION OF THE DRAWINGS

FIG. 1 is a cross-sectional view showing a periphery of a contact region between a shield pipe and a metallic braid part according to a first embodiment.

FIGS. 2(A) to (C) are views showing one example of a connection process between a metallic braid part and a shield pipe. FIG. 2(A) is a view showing a state in which a metallic braid part is placed over a shield pipe and a welding band is fitted to a region of the metallic braid part to be welded; FIG. 2(B) is a view showing an intermediate state in which the metallic braid part is being inverted after welding; and FIG. 2(C) is a view showing a state in which the connection operation between the metallic braid part and the shield pipe has been completed.

FIGS. 3(A) and (B) show a manufacturing method according to a second embodiment. FIG. 3(A) is a view showing a state in which a metallic braid part is placed over a shield pipe and a welding band is fitted to a region of the metallic braid part to be welded; and FIG. 3(B) is a view showing a state in which the connection operation between the metallic braid part and the shield pipe has been completed.

FIGS. 4(A) and (B) show a manufacturing method according to a third embodiment. FIG. 4(A) is a view showing a state in which a metallic braid part is placed over a shield pipe and a welding band is fitted to a region of the metallic braid part to be welded; and FIG. 4(B) is a view showing a state in which the connection operation between the metallic braid part and the shield pipe has been completed.

### DETAILED DESCRIPTION OF EMBODIMENTS

Preferred embodiments of the present invention will now be explained.

(1) In a method of manufacturing a shield conductor according to a preferred embodiment, a metallic wire of a metallic braid part may be coated on a surface with copper or copper alloy, a welding band may be fitted to an outer peripheral side of an end part of the metallic braid part prior to welding, and the welding band may be melted in that state using an ultrasonic joining machine so as to connect the metallic braid part with a tubular part.

A coating is often applied in view of the necessity to prevent corrosion on the surface of the metallic braid part. However, if a coating is applied to the part to be connected, it is generally said that ultrasonic welding will be difficult. Accordingly, there have been problems of poor operational efficiency due to, for example, a need for temporarily removing the coating, performing ultrasonic welding, and thereafter performing an anti-corrosion process in the region where the coating was removed. With regard to this, according to the method described above, the tubular part and the metallic braid part can be joined by melting and fixing the welding band using an ultrasonic joining machine, even without removing the coating.

(2) A positioning part may be formed for positioning the welding band on the outer peripheral surface of the tubular part, and the welding band may be melted in a state positioned with the metallic braid part disposed between the tubular part and the welding band.

According to such a method, the welding operation can be done in a state with the welding band appropriately positioned, and thus inconsistencies in the welding region can be avoided.

Next, first to third embodiments will be described with reference to the drawings.

### First Embodiment

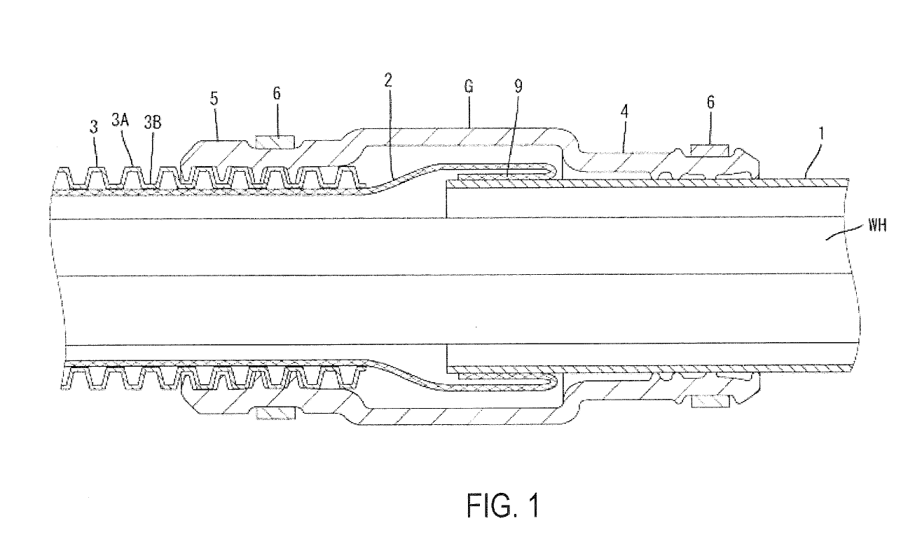

FIG. 1 shows an intermediate routing state of a wire harness WH which can connect, for example, a battery mounted in the rear side of a vehicle interior to an inverter mounted in an engine compartment, in a hybrid vehicle.

The wire harness WH may be composed of a plurality of electrical wires. During the intermediate routing of the wire harness WH, the wire harness WH may be inserted into an electrically conductive metallic shield pipe 1 (which corresponds to a part to be connected). The shield pipe 1 can be made of aluminum or aluminum alloy, for example, and may be arranged beneath a vehicle body floor.

After an end part of the shield pipe 1 is installed from beneath the floor into the engine compartment, it may be connected to a metallic braid part 2. The metallic braid part 2 and the shield pipe 1 together form one example of a shield conductor according to a preferred embodiment. The metallic braid part 2 and the shield pipe 1 are provided across a specified length to the point of connection with the inverter,

The metallic braid part 2 may be formed, for example, by braiding a copper metallic wire, provided on its surface with a tin coating, for example, in a mesh form and in an elongated tubular form. The wire harness which has been extracted from the shield pipe 1 may be inserted inside this metallic braid part 2. The end part of the metallic braid part 2 may be connected and fixed to the end part of the shield pipe 1 by a welding method as explained below, and the shield conductor according to a preferred embodiment is thus formed.

Other than a part of the length of the metallic braid part at a side connected to the shield pipe 1, the metallic braid part 2 may be inserted into a corrugated tube 3, and the end part of the metallic braid part 2 may extend to a connection part of the inverter not shown in the drawings. Thus, the wire harness WH may extend for the length of the shield pipe 1 and the metallic braid part 2, and shielding can be ensured.

The corrugated tube 3 may be formed, for example, of synthetic resin as a one piece elongated tubular member. A peripheral surface of the corrugated tube 3 may be formed in an accordion shape with repeating convex parts 3A and concave parts 3B, and has good flexibility. A grommet G used as a seal may be mounted so as to bridge between this corrugated tube 3 and the shield pipe 1.

The grommet G may be formed as a one piece member and may be formed of rubber material (for example, EPDM). A pipe side end part 4 may be formed at one end of this grommet G, and a corrugated side end part 5 may be formed at another end. The pipe side end part 4 and the corrugated side end part 5 may both be formed in a tubular shape. The pipe side end part 4 can have the end part of the shield pipe 1 inserted to its inner side, and the corrugated side end part 5 can pass over an outer peripheral side of the corrugated tube 3. Outer peripheral surfaces of the pipe side end part 4 and the corrugated side end part 5 may both be secured by, for example, a well-known bonding band, whereby the corrugated side end part 5 may be connected and fixed in a sealed state with respect to the corrugated tube 3, and the pipe side end part 4 may be connected and fixed in a sealed state with respect to the shield pipe 1.

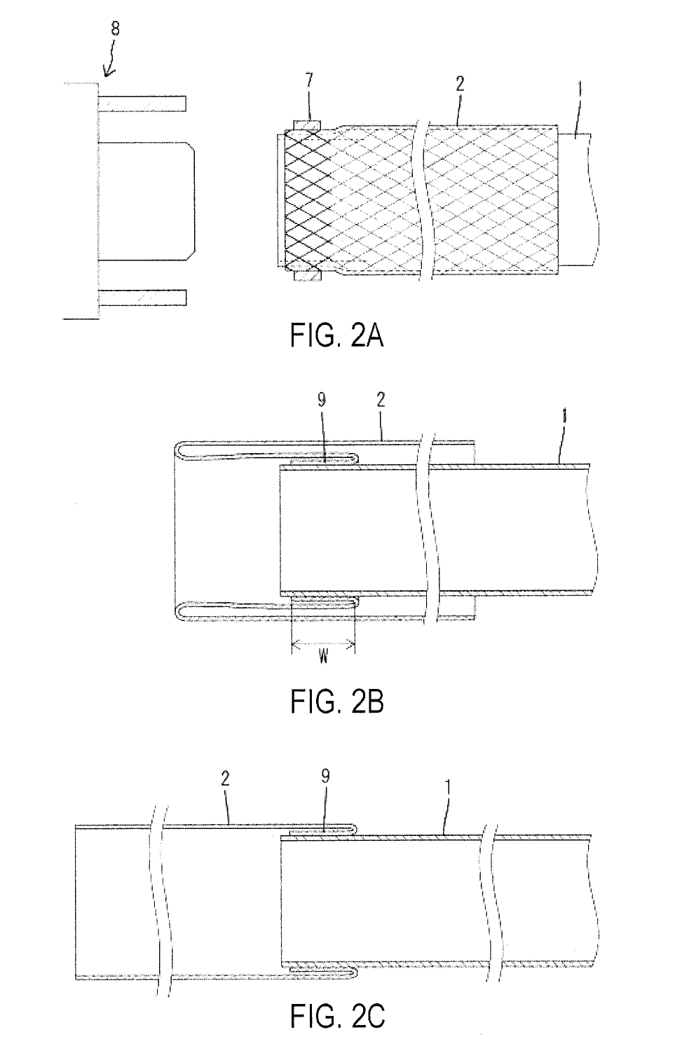

Next, one example of a connection method between the metallic braid part 2 and the shield pipe 1 will be described (see FIGS. 2(A) to (C)).

First, as shown in FIG. 2(A), an entire length of the metallic braid part 2 may be placed over the shield pipe 1 along a longitudinal direction. At this time, it is preferable that a terminal end part of the metallic braid part 2 does not protrude from an end surface of the shield pipe 1 in a longitudinally outward direction. The reason for this is to avoid damaging a cover of the electrical wire which forms the wire harness WH by the terminal end of the metallic braid part 2 protruding from the shield pipe 1.

In this state, a welding band 7 may be fitted to an outer peripheral surface of the end part of the metallic braid part 2. The welding band 7 may be formed as a metallic ring, and may have an inner bore that can fit onto the outer peripheral surface of the metallic braid part 2, while maintaining a small space between the welding band 7 and the outer peripheral surface of the metallic braid part 2. In this embodiment, the material of the welding band 7 may be copper or copper alloy, for example, but it is possible to use other materials if they provide sufficient joining force relative to the metallic braid part 2 and the shield pipe 1 when melted by an ultrasonic joining machine 8. Also, the welding band 7 may be formed thin-walled such that it will melt entirely within a specified welding time.

After completing the attachment of the welding band 7 as described above, the welding band 7 may be set to the ultrasonic joining machine 8 in that condition, and an ultrasonic welding operation is carried out. During this operation, the welding band 7 entirely melts and flows through the mesh of the metallic braid part 2 into a space between the metallic braid part 2 and the shield pipe 1. Then, after this melted member hardens, the outer peripheral surface side of the shield pipe 1 and the inner peripheral surface side of the metallic braid part 2 are connected to each other via the melted member. Thus, a substantially uniform joining state can be obtained across the entire periphery. In the area shown by W in FIG. 2(B), a welding region (joining region) 9 may be provided between the metallic braid part 2 and the shield pipe 1 in the lengthwise direction.

When the welding between the metallic braid part and the shield pipe is completed in this manner, the metallic braid part 2 may be inverted about the welding region 9 so as to be removed from the shield pipe 1 (see FIG. 2(B)). The connection operation between the shield pipe 1 and the metallic braid part 2 is complete when the metallic braid part 2 is fully removed from the shield pipe 1 (the state shown in FIG. 2(C)).

According to the shield conductor of the present embodiment manufactured in the manner described above, even if a caulking ring is not used as in the prior art, it is possible to connect the metallic braid part 2 with the shield pipe 1 by welding across the entire periphery. In contrast to this, even if the metallic braid part 2 and the shield pipe 1 are secured using a caulking ring as in the prior art, the roundness of the caulking ring is not necessarily maintained in the caulking condition, and both members are not attached uniformly across the entire periphery. Thus, there is room for improvement with respect to electrical connection reliability. If the metallic braid part 2 and the shield pipe 1 are ultrasonically welded using the welding band 7 as in the present embodiment, the metallic braid part 2 and the shield pipe 1 can be connected such that they are attached across the entire periphery. Therefore, the reliability of electrical connection can be increased, and inconsistencies in the connection quality can be suppressed. Also, with a caulking ring as in the prior art, the caulking part will be protruding outwardly, and thus there is a need for a space for the grommet G to avoid contacting the caulking part. Due to this arrangement, there is a concern that the grommet G will grow in size, but the present embodiment avoids this and, instead, contributes to a decrease in the size of the grommet G.

In addition, in the present embodiment as described above, the end part of the metallic braid part 2 may be folded to the inner side such that the terminal end of the metallic braid part 2 does not protrude outwardly. Thus, there is no need to carry out a terminal end process to address any unraveling of the wire terminal end of the metallic braid part 2. When using ultrasonic welding as in the present embodiment, the welding can be performed on the terminal end of the metallic wire as well, and thus the problem of the metallic wire unraveling does not even arise.

In addition, a tin coating may be applied to the surface of the metallic wire of the metallic braid part 2, but as explained above it is difficult to connect a component to which such a tin coating is applied to a part to be connected directly using ultrasonic welding. Therefore, if the metallic braid 2 and the shield pipe 1 are to be ultrasonically welded directly, measures must be taken, such as removing the tin coating of the end part prior to ultrasonic welding, or, at the start, refraining from applying the tin coating to the end part. However, by using the welding band 7 as the joining means as done in the present embodiment, the labor to remove the tin coating and so forth can be omitted, and operational efficiency can be improved.

### Second Embodiment

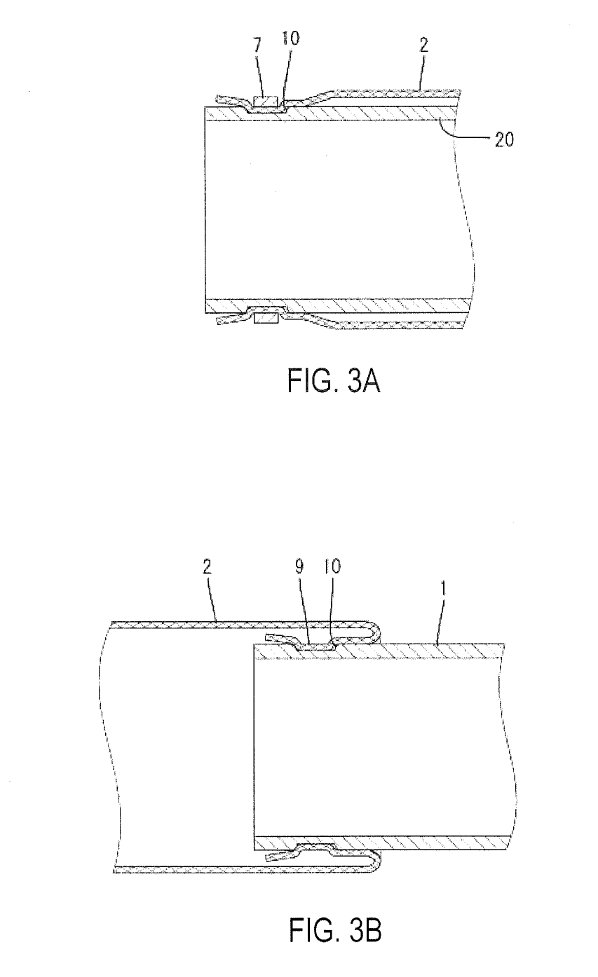

FIGS. 3(A) and (B) show a manufacturing method according to a second embodiment. In the second embodiment, an annular groove 10 formed as a depression is used for positioning on an outer peripheral surface of an end part of a shield pipe 20. This annular groove 10 may be formed across the entire periphery of the shield pipe 20, and may be formed wider than the width of the welding band 7. Also, although not shown in detail, a split groove may be cut into the welding band 7 along an axial direction, and the welding band 7 can be expanded and returned elastically, with the split groove as a boundary.

For the process of ultrasonic welding, after placing the metallic braid part 2 over the shield pipe 20, the welding band 7 may be attached to the metallic braid part 2 (see FIG. 3(A)). Then, upon positioning the welding band 7 inside the annular groove 10, due its own elasticity, the welding band 7 can be reduced slightly in diameter and can apply a constricting force to the metallic braid part 2. Therefore, the welding band 7 is appropriately positioned axially relative to the metallic braid part 2, and inadvertent misalignment of the metallic braid part 2 can be preemptively avoided during the welding operation. Accordingly, inconsistencies in the joining position of the metallic braid part 2 relative to the shield pipe 20 are avoided, and this contributes to ensuring the joining quality.

In this manner, upon completion of the ultrasonic joining operation, the welding region 9 of the metallic braid part 2 may be formed in the depressed shape of the annular groove 10 (see FIG. 3(B)).

Other structures of this embodiment are similar to those in the first embodiment and produce similar operational effects.

### Third Embodiment

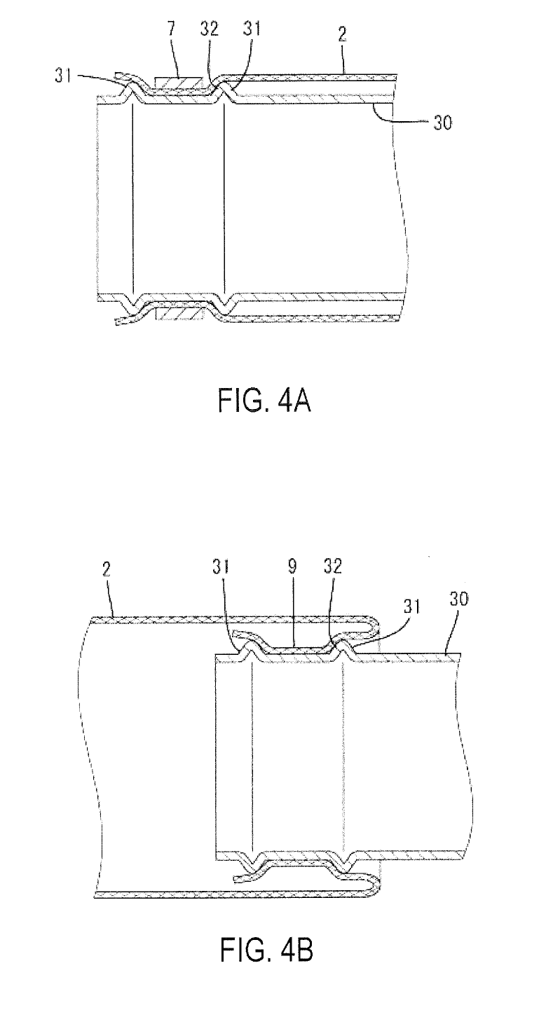

FIGS. 4(A) and (B) show a manufacturing method according to a third embodiment. In this embodiment, a pair of flanges 31 and 31 may be formed on a shield pipe 30, and the welding band 7 may be positioned between them.

In other words, the two flanges 31 and 31 may be formed at an end part of the shield pipe 30, with a specified clearance between the two flanges 31 and 31 in the lengthwise direction, such that they extend along the entire periphery. Both flanges 31 may be formed such that an inner peripheral surface side of the shield pipe 30 is concave and an outer peripheral surface side is protruding. As a result, an annular groove 32 used in positioning is formed on the outer peripheral surface of the shield pipe 30 in a region interposed between the flanges 31.

In the third embodiment formed in this manner, it is possible to weld the metallic braid part 2 and the shield pipe 30 using the same method as in the second embodiment. In this case as well, the welding region 9 may be formed in that concave shape inside the annular groove 32.

### Other Embodiments

The present invention is not limited to the embodiments described in the above explanations and the figures, but embodiments such as the following, for example, are encompassed by the technical scope of this invention.

(1) In the above described embodiments, a circularly shaped member was used as the welding band 7, but it would also be suitable to wrap metallic foil around it in a belt-like form. Such a member is encompassed by the welding band 7 of the preferred embodiments.

(2) In the above described embodiments, the shield pipes 1, 20 and 30 are shown as parts to be connected to the metallic braid part 2, but they are not limited to this and could also be, for example, electrically conductive metallic components provided with a tubular part.

(3) In the above described embodiments, ultrasonic welding is described as a welding process to connect the shield pipe 1 and the metallic braid part 2, but this can be replaced by resistance welding or soldering or the like.

(4) Prior to ultrasonic welding, it would be suitable to remove the tin coating from the end part of the metallic braid part 2, and it also would be suitable to remove the oxide coating from the outer peripheral surfaces of end parts of the shield pipes 1, 20 and 30. If this is done, the welding strength can be further increased.

(5) In the above described embodiments, the shield pipe 1 is shown as the part to which the metallic braid part 2 is to be connected, but this is not limited to pipe components. For example, a component having a connection region like a shield shell that has a tubular part would also be suitable. Also, it is not necessary to form the entire body of the tubular part from a metallic component. For example, the connection surface of the metallic braid part can be formed of electrically conductive metal, and the remainder can be formed of resin.

(6) In the above described embodiments, the case is described in which a tin coating is applied to the metallic braid part, but it is also suitable to apply other coatings, such as a nickel coating.

(7) In the above described embodiments, the annular groove 10 is described as being formed as a one piece member to position the welding band 7 on the shield pipe 1, but it is also suitable to provide a positioning means that is a separate member. Also, the positioning direction is not limited to the longitudinal direction of the shield pipe 1, and positioning could be done, for example, relative to the circumferential direction.

What is claimed is:

1. A method of manufacturing a shield conductor by connecting a metallic braid part formed of tubularly braided metallic wire to a part to be connected provided with a tubular part having electrical conductivity, the method comprising:
fitting the metallic braid part to an outer peripheral surface of an end part of the tubular part to form a fitting region;
attaching a metallic welding band formed in a ring shape in the fitting region with the metallic braid part fitted to the end part of the tubular part;
melting the welding band that is attached in the fitting region; and
welding the tubular part to the metallic braid part along a circumferential direction of the tubular part.

2. The method recited in claim 1, wherein
the metallic wire of the metallic braid part is coated on a surface with copper or copper alloy,
the welding band is fitted to an outer peripheral surface of an end part of the metallic braid part prior to welding, and
the welding band fitted to the end part of the metallic braid part is melted using an ultrasonic joining machine such that the welding band joins the metallic braid part with the tubular part.

3. The method recited in claim 1, further comprising
forming a positioning part for positioning the welding band on the outer peripheral surface of the tubular part, wherein
the melting of the welding band includes melting the welding band positioned with the metallic braid part disposed between the tubular part and the welding band.

4. The method recited in claim 3, wherein
the positioning part has a first width dimension that is greater than a second width dimension of the welding band, and
the attaching of the welding band includes locating the welding band inside the positioning part.

5. The method recited in claim 3, wherein
the positioning part is a concave portion formed in the outer peripheral surface of the tubular member.

6. The method recited in claim 3, wherein
the positioning part is an annular groove formed in the outer peripheral surface of the tubular member.

7. The method recited in claim 1, further comprising
forming a pair of positioning parts for positioning the welding band on the outer peripheral surface of the tubular part, the positioning parts being spaced apart by a specified clearance.

8. The method recited in claim 7, wherein
at least one of the positioning parts protrudes from the tubular member.

9. The method recited in claim 8, wherein
the at least one positioning part protrudes in a direction toward the metallic braid part.

10. The method recited in claim 1, wherein
a terminal end of the metallic wire of the metallic braid part extends parallel to an outer peripheral surface of the metallic braid part, the terminal end being disposed in the fitting region.

11. The method recited in claim 1, wherein
a terminal end of the metallic wire of the metallic braid part is disposed inside of the metallic braid part, the terminal end being disposed in the fitting region.
